(19) United States
(12) Patent Application Publication
(10) Pub. No.: US 2026/0274638 A1
(43) Pub. Date: Sep. 17, 2026

(54) METHOD FOR EMPTYING BEVERAGE CONTAINERS

(71) Applicant: GUILLIAMS GREEN POWER NV, Boutersem (BE)

(72) Inventors: Rohald GUILLIAMS, Boutersem (BE); Ruben GUILLIAMS, Boutersem (BE)

(21) Appl. No.: 19/167,261

(22) PCT Filed: Mar. 21, 2024
(86) PCT No.: PCT/IB2024/052706

§ 371 Date: Sep. 19, 2025

(30) Foreign Application Priority Data
Mar. 22, 2023 (BE) 2023/5217

(51) Int. Cl. B67C 9/00; B67B 7/06

(52) U.S. Cl. CPC B67C 9/00; B67B 7/06

(57) ABSTRACT

The present invention relates to a method for emptying beverage containers, the method comprising supplying a predetermined number of closed beverage containers filled with a beverage, wherein the predetermined number of supplied beverage containers are opened simultaneously by means of a decapping system, and wherein the beverage is subsequently extracted from the predetermined number of opened beverage containers by means of an extraction system comprising suction tubes, wherein the suction tubes are moved into the beverage containers by means of a downward movement, and wherein the suction tubes extract the beverage from the beverage container under a pressure of up to 0.9 bar. The present invention also relates to a device for emptying beverage packages.

### TECHNICAL FIELD

The invention relates to a method for emptying beverage containers, as well as a device for this purpose.

### PRIOR ART

When filling beverage containers, situations may arise for various reasons in which a container containing a beverage cannot be distributed for sale. Beverage containers, such as bottles, may be improperly filled, for example, because the quantity of beverage in the container is not sufficient to meet the requirements, because the beverage container itself does not meet certain requirements (“is not properly adjusted or equipped”), or because the container of beverage is returned from the distribution channels to the manufacturer. Furthermore, it is possible that the contents of correctly filled beverage containers expire before they can be sold.

In all these circumstances, the container should be opened again and the contents should be destroyed, or it should be poured into a collection tank before being processed again, such as through ethanol recovery in the case of alcoholic beverages.

Emptying beverage containers by turning them upside down after opening has the disadvantage of drawing in air, which slows down the emptying. In addition, with beverages containing CO₂ foam will be created that also slows down the emptying process and can lead to incompletely emptied containers.

Other known methods use needles, tubes or straws that are introduced into the containers. WO2006035290, for example, discloses a method for processing “incorrectly filled containers” containing a beverage, wherein gas under pressure is supplied into the container via the supply line, and in which a positive pressure is developed in that container so that the beverage is driven out of the container. This procedure is disadvantageous because the supply of pressurized gas may also cause foam formation. In addition, there is a high chance of leakage. The same problem occurs with U.S. Pat. Nos. 4,519,427, 4,662,411, 3,913,802 and DE4122637, in which gas under pressure is also provided in the containers.

WO9212925 also describes a method wherein a gas is introduced into the containers to expel the contents.

U.S. Pat. No. 3,870,175 describes a system for puncturing closed cans, after which the cans are emptied and crushed.

Moreover, known methods and devices are often based on moving the containers toward the needles, tubes or straws. This is not very efficient (slow) and costs a lot of energy.

The present invention aims to find a solution for at least some of the above problems. In particular, the present invention aims to provide a method for emptying beverage containers with increased efficiency, where large quantities can be processed and where losses are minimized.

### SUMMARY OF THE INVENTION

The invention relates to a method for emptying beverage containers according to claim 1. The beverage present in the beverage containers is extracted from the beverage containers using suction tubes at a pressure of maximum 0.9 bar.

Preferred forms of the method are set out in claims 2-13.

In a second aspect, the invention relates to a device for emptying beverage containers according to claim 14. The device is provided with suction tubes suitable for extracting beverages from beverage containers that are connected to a vacuum line.

The invention is advantageous because foam formation during extraction is reduced or even avoided. Moreover, the method and the device are advantageous because a more energy-efficient emptying process is achieved. The inventors also noted that the method and device of the present invention provide for an emptying process where the risk of leakage is reduced or even avoided.

Furthermore, the present invention provides a method and a device that enables the emptying of large quantities of beverage containers in a relatively short period of time.

A further advantage of the invention is the minimization of losses during the emptying process. This is also advantageous if excise tax refunds need to be applied for on the recovered beverage, but also for the further processing of the emptied containers.

### DETAILED DESCRIPTION

The invention relates to a method for emptying beverage containers.

Unless otherwise defined, all terms used in the description of the invention, including technical and scientific terms, have the meanings as commonly understood by a person skilled in the art to which the invention pertains. For a better understanding of the description of the invention, the following terms are explained explicitly.

The term “beverage containers” as used in the text should be understood as containers used to store and transport beverages such as water, soft drinks, juice, milk and alcoholic beverages such as beer, wine and spirits. These containers can have different shapes and materials, such as plastic bottles, cans, cardboard boxes, glass bottles, and so on.

The term “decapping”, as used in the text, should be understood as the removal of the cap or closure from a bottle, carton, jar, tube or other similar container. The purpose of decapping can differ depending on the context. Decapping can be done manually, for example by turning or pulling, or with the help of a decapper.

The term “decapper”, as used in the text, is to be understood as a means used to remove the cap or closure from a bottle, carton, jar, tube or other similar container. Non-limiting examples are a bottle opener, an uncorker or a can opener, but also any means capable of loosening a screw cap.

The term “cap”, as used in the text, is to be understood as a closure used to close an opening of a bottle, jar, tube or other similar container. Caps come in different shapes and materials, depending on the type of container and the contents stored inside. For example, caps can be made of plastic, metal or cork and can be screw caps, twist caps, press-on caps or flip-top caps. Most caps are easy to remove to use the contents of the container.

The term “case” is synonymous with the term “crate” and should be understood as a container in which several bottles or cans are stored and transported. The case is designed to hold a predetermined number of beverage containers, such as six, twelve or twenty-four. Cases are often used to transport beverage containers from the store to the home, or to store beer in a refrigerator or other storage location.

In this document, “a” and “the” refer to both the singular and the plural, unless the context presupposes otherwise. For example, “a segment” means one or more segments.

When the term “around” or “about” is used in this document with a measurable quantity, a parameter, a duration or moment, and the like, then variations are meant of approx. 20% or less, preferably approx. 10% or less, more preferably approx. 5% or less, even more preferably approx. 1% or less, and even more preferably approx. 0.1% or less than and of the quoted value, insofar as such variations are applicable in the described invention. However, this must be understood to mean that the value of the magnitude where the term “approximately” or “around” is used, is itself specifically disclosed.

The terms “comprise,” “comprising,” “provided with,” are synonyms and are inclusive or open terms that indicate the presence of what follows, and which do not exclude or prevent the presence of other components, characteristics, elements, members, steps, as known from or disclosed in the prior art.

The terms “contain,” “containing,” “consist of,” “consisting of,” “include,” “including” are synonyms and are exclusive or closed terms indicating the presence of what follows, and which exclude or preclude the presence of other components, features, elements, members, steps, known or described in the prior art.

Quoting numeric intervals by the endpoints includes all integers, fractions, and/or real numbers between the endpoints, including those endpoints.

In a first aspect, the invention relates to a method for emptying beverage containers.

The method preferably comprises supplying a predetermined number of closed beverage containers that are filled with a beverage, wherein the predetermined number of supplied beverage containers are opened simultaneously by means of a decapping system, and wherein the beverage is subsequently extracted from the predetermined number of opened beverage containers by means of an extraction system.

The current method can be applied to a wide variety of beverage containers. Preferably, the supplied beverage containers come from the same type of beverage container. Preferably, the supplied beverage containers are substantially identical in shape and material. In a preferred form, the beverage containers are provided with a cap as a closure. The cap is preferably made of plastic, metal or cork, more preferably metal. In another preferred form, the cap is made of plastic. The cap is preferably a screw cap, twist cap, cork, or crown cork, preferably a crown cork. In another preferred form, the cap is a twist cap.

In a preferred form, the beverage containers are selected from the list of: glass bottles, plastic bottles, cans, or cardboard boxes, preferably glass bottles or plastic bottles, even more preferably glass bottles.

The contents of the supplied beverage containers can vary between 10 and 200 cl. Such as 25 cl, 33 cl, 50 cl, 75 cl, 100 cl, 200 cl, but also every value in between.

The predetermined number of closed beverage containers that are supplied can be any number between 1 and 100, preferably between 1 and 50, such as 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50. Preferably, the predetermined number is chosen from the list of 6, 12, 24 or 48.

In a preferred form, the beverage containers are supplied in a case. In these embodiments, the supplied beverage containers are positioned in a case. In a further preferred form, the case is immobilized during decapping by means of two pneumatic stops on the side surfaces of the case.

The case can be made of plastic, metal, cardboard or wood. In a preferred form, the case is made of plastic, preferably high-density polyethylene (HDPE). HDPE is a thermoplastic polymer known for its strength, stiffness and toughness, as well as its ability to be recycled. HDPE is resistant to tearing, breaking and deformation, making it ideal for making beer crates that can be used repeatedly. HDPE plastic is also resistant to chemicals and can be easily cleaned and disinfected, making it perfect for use in the food industry, such as transporting beverage containers.

Wooden cases are often used in craft breweries or for special events. They are usually made of solid wood and can have a rustic look. Cases made of metal, such as steel or aluminum, are durable and can be recycled. They are sometimes used for commercial applications or by breweries wanting to distribute their own beer. Cardboard cases are single-use and are often lightweight and easy to carry. They are sometimes used for events or parties where beer is offered in bulk.

The dimensions of the case depend on the capacity of the case. The capacity of a case depends on the size of the bottles or cans placed in it. The height of the case is preferably between 10 and 100 cm, preferably between 10 and 50 cm, more preferably between 20 and 40 cm. The width of the case is preferably between 10 and 100 cm, preferably between 10 and 50 cm, more preferably between 20 and 40 cm. The length of the case is preferably between 10 and 100 cm, preferably between 20 and 60 cm.

Supplying in a case is advantageous as the beverage containers are at least partially immobilized during the opening of the beverage containers and the extraction of the beverage. In addition, the beverage containers do not have to leave the case during the method and can then be transported back from the emptying process in the same case.

The beverage in the beverage containers can be alcoholic or non-alcoholic, such as water, soft drinks, juice, milk, beer, wine and spirits. In a preferred form, the beverage in the beverage containers is a carbonated beverage, an alcoholic beverage or a carbonated alcoholic beverage.

The invention is particularly advantageous for carbonated beverages because foam formation is avoided. The invention is also particularly advantageous for alcoholic beverages because by minimizing losses the reimbursement of any excise duties paid can be precisely calculated.

In a specific preferred form, the method comprises supplying a predetermined number of closed beverage containers that are filled with a beverage, wherein the predetermined number of supplied beverage containers are opened simultaneously by means of a decapping system, and wherein the beverage is subsequently extracted from the predetermined number of opened beverage containers by means of an extraction system comprising suction tubes, wherein the suction tubes are moved into the beverage containers by means of a downward movement, and wherein the suction tubes extract the beverage from the beverage container under a pressure of up to 0.9 bar.

The low pressure, lower than atmospheric pressure, ensures that the beverage is sucked out of the container instead of pushed out of the container, as with conventional techniques. As a result, no external pressure or pressurized gas is added to the container and foam will therefore develop less or not at all. This will allow the beverage containers to be emptied better and more completely.

In a preferred form, the beverage containers are supplied by means of a conveyor belt. The conveyor belt preferably runs through the decapping system and the extraction system.

The decapping system is suitable for opening the supplied beverage containers. Preferably, the decapping system comprises one or more decappers. Preferably, the decapping system includes a number of decappers equal to the predetermined number of beverage containers supplied.

In a preferred form, the supplied beverage containers are opened using the decappers. The decappers preferably move downwards towards the beverage containers. Preferably, the decapping system comprises a platform that can be moved downwards and upwards, on which the decappers are provided.

In a preferred form, the decapping system is an uncorking system. In this embodiment, the decappers are uncorkers suitable for removing a crown cork or cork from a beverage container. An uncorker can be of different types depending on the type of bottle and cork that needs to be removed. In a preferred form, the decapper is an uncorker suitable for removing crown corks. In another preferred form, the decapper is an uncorker suitable for removing corks. In another preferred form, the decapper is a decapper suitable for removing a twist cap. In a preferred form, the removed caps are collected in a container.

In a preferred form, the uncorkers are provided with electromagnets. This is advantageous because during decapping, metal crown corks are attracted to the electromagnets and thus remain attached to the uncorking system. In this preferred form, the crown corks can then be collected in a container by disconnecting the electromagnets.

In a preferred form, the beverage containers are immobilized by means of a clamp during decapping.

The extraction system is equipped with suction tubes suitable for extracting the beverage from the beverage containers. The suction tubes are preferably connected to a vacuum line for this purpose. In a specific preferred form, the suction tubes extract the beverage from the beverage container under a pressure of at most 0.9 bar. Preferably, this pressure is a maximum of 0.8 bar, even more preferably a maximum of 0.7 bar, even more preferably a maximum of 0.6 bar, even more preferably a maximum of 0.5 bar.

In a preferred form the pressure is between 0.1 and 0.9 bar. Preferably, this pressure is between 0.2 and 0.8 bar, even more preferably between 0.3 and 0.7 bar, even more preferably between 0.4 and 0.6 bar, even more preferably about 0.5 bar.

This pressure can be achieved using a vacuum pump, by creating a low vacuum by moving air.

The term “low vacuum” refers to an environment with low air pressure, where the pressure is below atmospheric pressure. In general, low vacuum is defined as a pressure range between approximately 1 and 0.001 bar.

The inventors have unexpectedly discovered that this low pressure is ideal for extracting beverages from beverage containers. This is especially true in the case of carbonated beverages as no extra air or pressure needs to be added to the beverage container. The beverage container also does not need to be sealed.

In a preferred form, the opened beverage containers are not sealed during the extraction of the beverage. This is a necessity in conventional emptying techniques and requires an additional process step.

Preferably, the extraction system includes a number of suction tubes equal to the predetermined number of beverage containers supplied.

In a preferred form, the suction tubes move downwards towards and into the beverage containers. In a further preferred form, the beverage is extracted from the beverage container during the downward movement of the suction tubes. Preferably, the extraction system comprises a platform that can be moved downwards and upwards, on which the suction tubes are provided. In a further preferred form, the beverage is extracted when the suction tubes reach the bottoms of the beverage containers.

In a preferred form, the time required to extract the beverage from the beverage containers is a maximum of 5 seconds, preferably a maximum of 4 seconds, even more preferably a maximum of 3 seconds, even more preferably a maximum of 2 seconds, even more preferably a maximum of 1 second. In this context, the time period is calculated from the start of the extraction of the beverage until the suction tube touches the bottom of the bottles.

In a preferred form, the suction tubes are provided with a suction valve, preferably a spring-loaded suction valve. The spring-loaded suction valve is advantageous because damage to the suction tubes when hitting the bottom can be reduced or even avoided. In addition, this allows the bottles to be emptied optimally, as it is possible to empty to the bottom.

In a preferred form, at least 90 volume % of the beverage is extracted from the beverage containers, preferably at least 95 volume %, more preferably at least 99 volume %.

In a preferred form, the beverage is extracted from each beverage container simultaneously. This is advantageous in combination with the short extraction time and ensures a time-efficient method.

In a preferred form, the extracted beverage is collected in a collection tank. In a further preferred form, the volume and alcohol percentage of the collected beverage are measured. In a further preferred form, the reimbursement of excise duties already paid is calculated on the basis of the measured volume and the measured alcohol percentage.

The volume and alcohol percentage are preferably measured when the collected beverage is pumped away from the collection tank to a subsequent storage location or a means of transport. In this process, the collected beverage will be pumped through a flow meter, whereby the volume and alcohol percentage of the collected beverage can be measured and registered. This data can, for example, be passed on to a supplier of the beer bottles so that the excess excise duties can be reclaimed.

In a specific preferred form, the method comprises supplying a predetermined number of glass beer bottles that are filled with beer and sealed with a crown cork, where the predetermined number of beer bottles supplied are opened simultaneously by means of an uncorking system, and wherein the beer is then simultaneously extracted from the predetermined number of opened beverage containers by means of an extraction system comprising suction tubes, wherein the suction tubes are moved into the beverage containers by means of a downward movement, and wherein the suction tubes extract the beverage from the beverage container under a pressure of up to 0.9 bar.

In a specific preferred form, the method comprises supplying a predetermined number of plastic bottles filled with beverage and closed with a twist cap, wherein the predetermined number of supplied plastic bottles are opened simultaneously by means of a decapping system, and wherein the soft drink is then simultaneously extracted from the predetermined number of opened plastic bottles by means of an extraction system comprising suction tubes, wherein the suction tubes are moved into the plastic bottles by means of a downward movement, and wherein the suction tubes extract the beverage from the plastic bottles under a pressure of up to 0.9 bar.

In a second aspect, the invention relates to a device for emptying beverage containers.

In an embodiment of the invention the device comprises:
a decapping system;
an extraction system;
a conveyor belt positioned through the decapping system and the extraction system suitable for guiding beverage containers through the decapping system and the extraction system.

In a preferred form, the decapping system comprises a predetermined number of decappers, wherein the decappers can be moved downwards and upwards. Preferably, the decapping system comprises a platform that can be moved downwards and upwards, and on which the decappers are provided. In a preferred form, the extraction system comprises a predetermined number of suction tubes, wherein the suction tubes are movable downwards and upwards. Preferably, the extraction system comprises a platform that can be moved downwards and upwards, and on which the suction tubes are provided. In a further preferred form, the number of decappers and the number of suction tubes are the same.

In a specific preferred form, the suction tubes are connected in fluid communication to a vacuum line.

In a specific preferred form of the invention the device comprises:
a decapping system, comprising a predetermined number of decappers, movable downwards and upwards;
an extraction system, comprising a predetermined number of suction tubes, movable downwards and upwards, wherein the suction tubes are connected in fluid communication to a vacuum line;
a conveyor belt positioned through the decapping system and the extraction system suitable for guiding beverage containers through the decapping system and the extraction system.

The connection between the suction tubes and the vacuum line is advantageous as it will provide a low pressure, less than atmospheric pressure, in the suction tubes. This ensures that the beverage is sucked out of the container instead of pushed out of the container, as with conventional techniques. As a result, no external pressure or pressurized gas is added to the container and foam will therefore develop less or not at all. This will allow the beverage containers to be emptied better and more completely.

The vacuum line is preferably connected to a vacuum pump, so that a low vacuum can be created by moving air.

The inventors unexpectedly discovered that the vacuum line and pump make a low pressure possible. This low pressure is ideal for extracting beverages from beverage containers. This is especially true in the case of carbonated beverages as no extra air or pressure needs to be added to the beverage container. The beverage container also does not need to be sealed.

In a preferred form, the suction tubes are provided with a spring-loaded suction valve.

In a preferred form, the decapping system is an uncorking system. In this embodiment, the decappers are uncorkers suitable for removing a crown cork or cork from a beverage container. An uncorker can be of different types depending on the type of bottle and cork that needs to be removed. In a preferred form, the decapper is an uncorker suitable for removing crown corks. In another preferred form, the decapper is a decapper suitable for removing a twist cap. In a preferred form, the removed caps are collected in a container.

In a preferred form, the uncorkers are provided with electromagnets. This is advantageous because during decapping, metal crown corks are attracted to the electromagnets and thus remain attached to the uncorking system. In this preferred form, the crown corks can then be collected in a container by disconnecting the electromagnets.

In a specific preferred form of the invention the device comprises:
an uncorking system, comprising a predetermined number of uncorkers, movable downwards and upwards;
an extraction system, comprising a predetermined number of suction tubes, movable downwards and upwards, wherein the suction tubes are connected in fluid communication to a vacuum line;
a conveyor belt positioned through the decapping system and the extraction system suitable for guiding beverage containers through the decapping system and the extraction system.

In a preferred form, the device is suitable for carrying out a method according to the first aspect.

In what follows, the invention is described by way of non-limiting examples illustrating the invention, and which are not intended to and should not be interpreted as limiting the scope of the invention.

### EXAMPLES

### Example 1: Emptying 25 cl Beer Bottles

Standard European glass beer bottles with a capacity of 25 cl, a height of 215 mm and a bottom diameter of 56 mm are supplied in a beer crate with dimensions 40 cm×30 cm×25 cm to an uncorking system via a conveyor belt.

The bottles are filled with lager with an alcohol content of 5.2 vol % and sealed with a crown cork. The uncorking system comprises 24 uncorkers positioned on a platform. The platform is moved downwards towards the bottles and positioned at the correct height to uncork the bottles. The uncorkers have an electromagnet on their support points, which attracts the crown corks after the bottles are opened. During opening, the case is immobilized by means of two pneumatic stoppers on two opposite side surfaces of the case. The bottles themselves are also clamped before uncorking to immobilize them. After uncorking, the platform moves back up.

The up and down movement of the platform of the uncorking system is done with a double linear guide with two electric cylinders and two servomotors, which are driven synchronously. The case height, which is proportional to the bottle height, can be entered by an operator via a touch panel. The decapping system is also equipped with photocells that can monitor the movement of the case and the bottles.

After uncorking, the platform moves upwards. A collection container rotates under this platform. The electromagnets that held the crown corks are disconnected and the crown corks are collected in a collection container. The collection container itself can be emptied by turning and tilting.

The conveyor belt then transports the container with opened beer bottles to the extraction system. The extraction system comprises 24 suction tubes positioned on a platform. The platform is moved downwards towards the bottles. As the platform moves downwards, the beer is sucked from the bottles. When the suction tubes reach the bottom of the bottle, more than 90% by volume, preferably more than 99% by volume, of the beer has been extracted from the bottle.

The suction tubes are equipped with a spring-loaded suction valve at the bottom, i.e. the part of the suction tube that faces the bottles and first touches the liquid surface. The spring-loaded suction valve is advantageous because damage to the suction tubes when hitting the bottom can be reduced or even avoided. In addition, this allows the bottles to be emptied optimally. The suction tubes are all connected to a vacuum line, so that the pressure in the suction tubes is approximately 0.5 bar. Bottle emptying takes about 0.9 seconds. The sucked beverage is collected in a collection tank. The platform then moves up again so that the suction tubes are removed from the bottles.

The emptied bottles in the case are then further transported via the conveyor belt, after which they can be stacked and loaded again for transport.

The volume and alcohol percentage are measured in the collecting tank containing the extracted beer. This data is passed on to the supplier of the beer bottles so that any excess excise duties can be reclaimed.

Using the method as described, 595 cases of 24 25 cl bottles can be emptied per hour.

The present invention should not be construed as being limited to the embodiments described above and certain modifications or changes may be added to the examples described without having to re-evaluate the appended claims. For example, the present invention has been described with reference to 25 cl beer bottles, but it is clear that the invention can be applied to, for example, beer bottles and soft drink bottles of any size or cases with a number of bottles ranging from 1 to 50.

### Example 2-8: Beverage Containers

Tables 1 and 2 below show some beverage containers that can be emptied using the current method and device:

TABLE 1

| | Example 2 | | Example 3 | | Example 4 | |
|---|---|---|---|---|---|---|
| | Beer bottle | | Sekt bottle | | Beer bottle | |
| Mouth type | Crown cork | | Crown cork | | Crown cork | |
| Mouth size | 22 | mm | 29 | mm | 26 | mm |
| Measure of volume | 250 | ml | 750 | ml | 750 | ml |
| Diameter | 56.30 | mm | 82.90 | mm | 79.50 | mm |
| Height | 212 | mm | 290 | mm | 291 | mm |

TABLE 2

| | Example 5 | | Example 6 | | Example 7 | |
|---|---|---|---|---|---|---|
| | Magnum | | Bordeaux | | Soft drink | |
| | bottle | | bottle | | bottle | |
| Mouth type | Crown cork | | Cork | | Twist cap | |
| Mouth size | 29 | mm | 18 | mm | 28 | mm |
| Measure of volume | 1500 | ml | 375 | ml | 500 | ml |
| Diameter | 110 | mm | 61.50 | mm | 67 | mm |
| Height | 360 | mm | 237.50 | mm | 190 | mm |

1. A method for emptying beverage containers, the method comprising:
supplying a predetermined number of beverage containers that are closed and filled with a beverage,
opening the predetermined number of beverage containers simultaneously by means of a decapping system, and
simultaneously extracted the beverage from the predetermined number of beverage containers that are open by means of an extraction system comprising suction tubes, wherein the suction tubes are moved into the beverage containers by means of a downward movement, and wherein the suction tubes extract the beverage from the beverage container under a pressure of up to 0.9 bar.

2. The method according to claim 1, wherein the beverage containers are bottles.

3. The method according to claim 1, wherein the beverage containers are positioned in a case.

4. The method according to claim 1, wherein the beverage containers are not closed during the extraction of the beverage.

5. The method according to claim 1, wherein the suction tubes are provided with a spring-loaded suction valve.

6. The method according to claim 1, wherein a time required to extract the beverage from the beverage containers is a maximum of 1 second.

7. The method according to claim 1, wherein at least 90 volume % of the beverage is extracted from the beverage containers, preferably at least 99 volume %.

8. The method according to claim 1, wherein the suction tubes extract the beverage under a pressure of a maximum of 0.7 bar.

9. The method according to claim 1, wherein the beverage is extracted from each of the beverage containers simultaneously.

10. The method according to claim 1, wherein the beverage containers are opened using an uncorking system, wherein the uncorking system comprises a number of uncorkers equal to a number of the beverage containers supplied.

11. The method according to claim 10, wherein the uncorkers comprise electromagnets.

12. The method according to claim 1, further comprising collecting the beverage that is extracted in a collection tank, and measuring a volume and alcohol percentage of the beverage when pumping a liquid out of this the collection tank through a flow meter to a subsequent storage location or means of transport.

13. The method according to claim 12, further comprising calculating reimbursement of excise duties already paid on the basis of the volume and the alcohol percentage.

14. A device for emptying beverage containers, comprising
a decapping system, comprising a predetermined number of decappers, movable downwards and upwards;
an extraction system, comprising a predetermined number of suction tubes, movable downwards and upwards, wherein the suction tubes are connected in fluid communication to a vacuum line; and
a conveyor belt positioned through the decapping system and the extraction system suitable for guiding beverage containers through the decapping system and the extraction system.

15. The device according to claim 14, wherein the suction tubes are provided with a spring-loaded suction valve.

16. The device according to claim 14, wherein the decapping system is an uncorking system, and wherein the decappers are uncorkers.

17. The device according to claim 16, wherein the uncorkers comprise electromagnets.

18. The method according to claim 7, wherein at least 99 volume % of the beverage is extracted from the beverage containers.

19. The method according to claim 8, wherein the pressure is a maximum of 0.5 bar.
